(19) United States
(12) Patent Application Publication
(10) Pub. No.: US 2009/0134614 A1
(43) Pub. Date: May 28, 2009

(54) Debris deflecting lift truck wheel guard

(76) Inventor: Steven Lee Johnson, Bowling Green, KY (US)

Correspondence Address: Steven L. Johnson, 230 Baskerville Road, Bowling Green, KY, 42101, US

(21) Appl. No.: 12/313,769

(22) Filed: Nov. 24, 2008

Related U.S. Application Data
(60) Provisional application No. 61/004,283, filed on Nov. 26, 2007.

(51) Int. Cl. B62D 25/18

(52) U.S. Cl. 280/847

(57) ABSTRACT

The debris deflecting lift truck wheel guard is comprised of a deflecting material assembly, preferably made of metal, synthetic, and/or natural materials, that is attached to a lift truck via at least one adjustable or fixed mode of attachment. The assembly is positioned so that the deflecting material extends down either in front of and/or behind the wheel toward the floor. As the truck moves, the deflecting material moves along the floor in the projected path of the wheel(s) and removes debris from that path. One debris deflecting lift truck wheel guard is needed per wheel or set of wheels to protect them all from premature wear. The debris deflecting lift truck wheel guard protects the wheel(s) of lift trucks from premature wear caused by contact with debris. This technology is unique in that it seeks to clear only the projected path of the wheel(s) of debris, as opposed to a larger portion of the floor, and it does so while the lift truck remains in normal operation.

### CROSS-REFERENCE TO RELATED APPLICATIONS

I am claiming the benefit of the filing date of Nov. 26, 2007 of Provisional application No. 61/004,283.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The debris deflecting lift truck wheel guard is an add-on apparatus for industrial lift trucks. One debris deflecting lift truck wheel guard is needed per wheel or set of wheels of a lift truck to protect all of the wheels. In this specification, the invention is referred to in the singular form when referring to one debris deflecting lift truck wheel guard and in the plural form when referring to multiple debris deflecting lift truck wheel guards. Three primary embodiments of this invention, which correlate to independent claims 1, 13, and 20, are described in the following specification. Several dependent claims describe features of the various secondary embodiments that are possible within each primary embodiment of the debris deflecting lift truck wheel guard.

Lift trucks usually operate in factories and warehouses, which regardless of the strictest cleanliness standards, tend to have debris on the floor. Lift trucks that run over debris on the floor are susceptible to two main problems that the debris deflecting lift truck wheel guard is designed to eliminate: flat-spotting and debris embedding.

Flat-spotting occurs when a lift truck runs over a piece of debris on the floor, and the debris lodges between the wheel and the floor, becomes stuck, and causes the wheel not to turn but to instead drag along the floor in a static position. As the wheel is dragged over the floor in a static position, the friction between the wheel and the floor causes the rubber or other material of which the wheel is comprised to wear away, creating a flat spot on the wheel. A wheel with a flat spot must be discarded and replaced, as it is no longer effective or safe to use on a lift truck. Flat-spotting causes wheels to have to be replaced prematurely, resulting in higher maintenance cost for the lift truck owner.

Debris embedding occurs when a lift truck runs over a piece of debris on the floor, and the weight of the truck causes the debris to become embedded in the solid rubber or other material of which the wheel is composed. A wheel that has debris embedded in it will begin to deteriorate prematurely, and the uneven ride it produces may create an unsafe condition for the lift truck operator. Debris embedding causes wheels to have to be replaced prematurely, resulting in higher maintenance cost for the lift truck owner.

I am aware of no other invention that has attempted to address these problems. The only thing remotely similar is U.S. Pat. No. 4,001,908, “Sweeping apparatus for coupling to a motorized vehicle.” This patent is substantially different from the debris deflecting lift truck wheel guard, however, because it is a sweeping apparatus that attaches to a lift truck, which is then used to clean an entire floor, not to protect the individual wheels of a lift truck. Debris deflecting lift truck wheel guards are not designed to clean floors but rather to simply protect the wheels of a lift truck by deflecting and/or removing debris from the immediate path of the wheels.

### BRIEF SUMMARY OF THE INVENTION

The first primary embodiment of the debris deflecting lift truck wheel guard corresponds to claim 1 and is comprised of a mounting plate, a deflecting-material holder, deflecting material, and at least two modes of attachment. The second primary embodiment of the debris deflecting lift truck wheel guard corresponds to claim 13 and is comprised of a deflecting-material holder, deflecting material, and at least one mode of attachment. The third primary embodiment of the debris deflecting lift truck wheel guard corresponds to claim 20 and is comprised of deflecting material and at least one mode of attachment. All three primary embodiments are preferably made of metal, natural, and/or synthetic materials and are attached to the lift truck near the wheel or set of wheels, so that the deflecting material, preferably but not necessarily a brush and/or bristles, extends either down in front of or behind the wheel, depending on whether the truck will primarily be driven forward or in reverse, and extends to touch the floor. As the truck moves, the deflecting material moves along the floor in the projected path of the wheel and removes debris from that path. The debris deflecting lift truck wheel guard will protect the wheels of lift trucks from flat-spotting and debris embedding, two conditions that cause premature wear and make it necessary for the wheels to be replaced frequently, at a significant cost to the lift truck owner. One debris deflecting lift truck wheel guard is needed per wheel or set of wheels to protect all of the wheels. The debris deflecting lift truck wheel guard can be made in different sizes and shapes to fit any model lift truck. As the dependent claims describe, the debris deflecting lift truck wheel guard can be made in a fully adjustable fashion, a partially adjustable fashion, or in a fixed fashion, and it can be made using a variety of modes of attachment.

### BRIEF DESCRIPTION OF THE SEVERAL VIEWS OF THE DRAWING

FIG. 1 depicts the side view of an adjustable embodiment of the debris deflecting lift truck wheel guard.

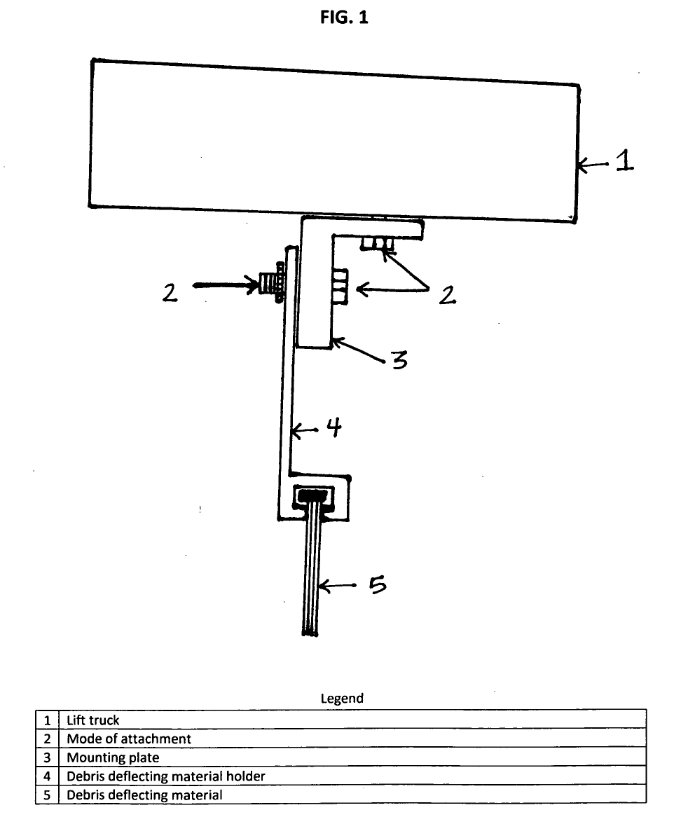

FIG. 2 depicts the front view of an adjustable embodiment of the debris deflecting lift truck wheel guard. Please note that the mounting plate, identified as Item 3 on FIG. 2, is shown as transparent, although it is not transparent in real life, so the viewer can see how it works with the deflecting-material holder (Item 4 on FIG. 2) behind it.

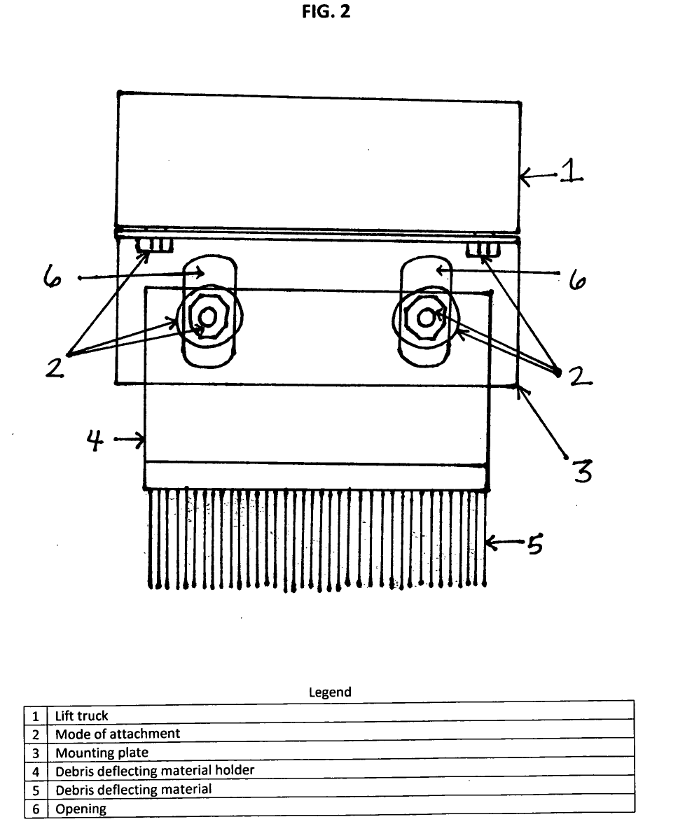

FIG. 3 depicts the side view of a non-adjustable embodiment of the debris deflecting lift truck wheel guard.

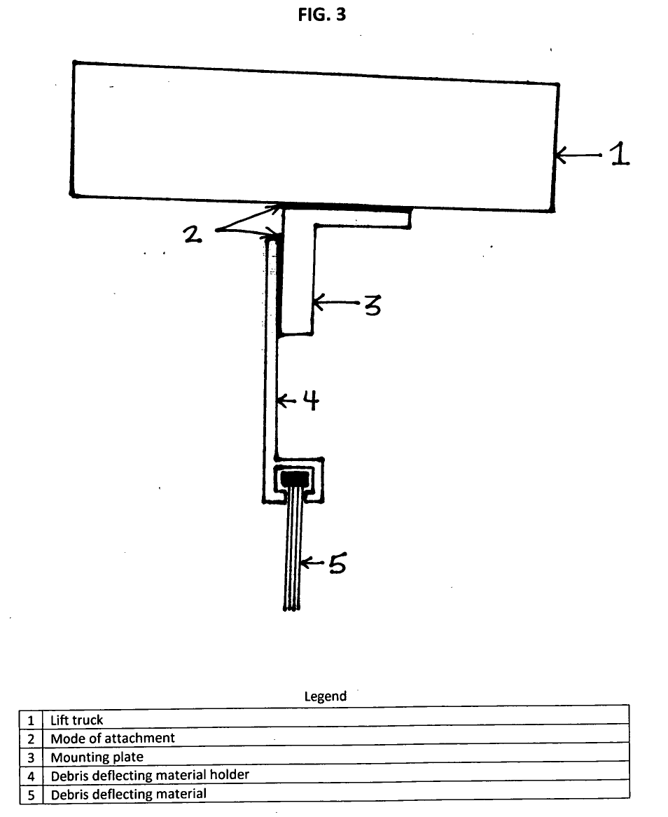

FIG. 4 depicts the front view of a non-adjustable embodiment of the debris deflecting lift truck wheel guard.

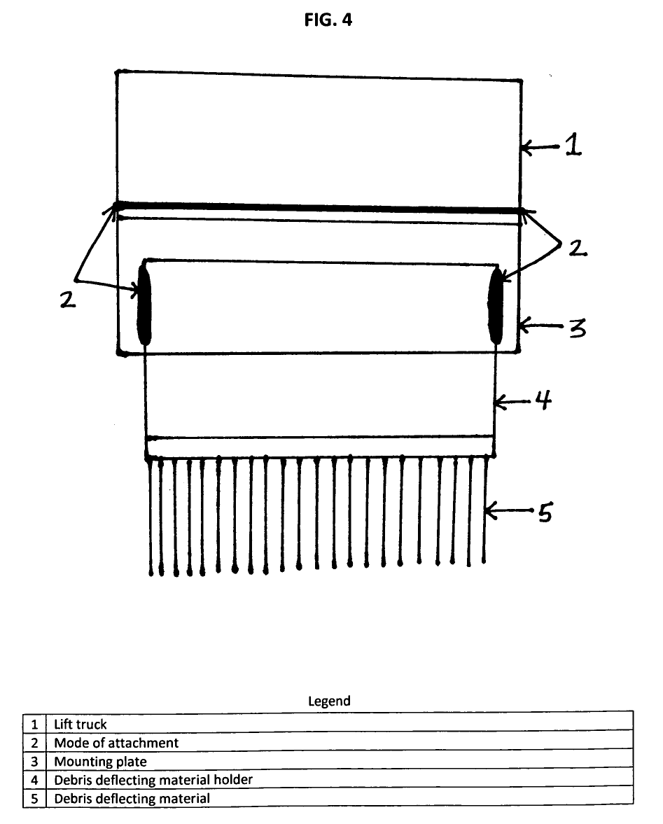

FIG. 5 depicts the side view of an adjustable embodiment of the debris deflecting lift truck wheel guard.

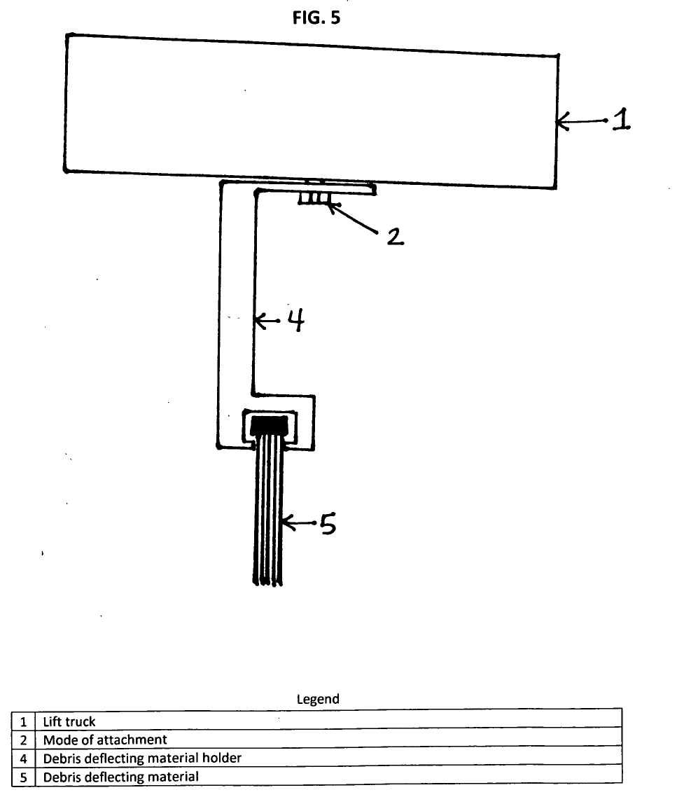

FIG. 6 depicts the front view of an adjustable embodiment of the debris deflecting lift truck wheel guard.

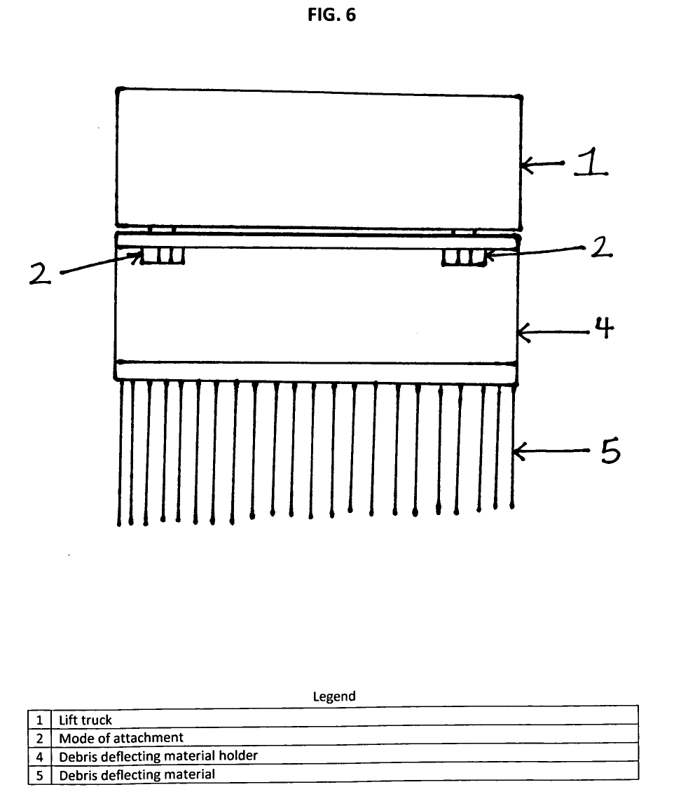

FIG. 7 depicts the side view of a non-adjustable embodiment of the debris deflecting lift truck wheel guard.

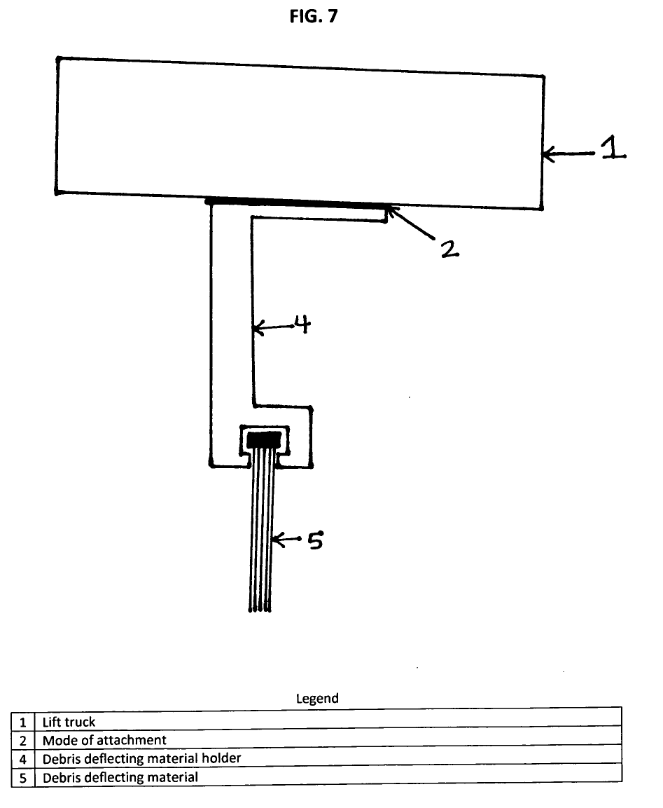

FIG. 8 depicts the front view of a non-adjustable embodiment of the debris deflecting lift truck wheel guard.

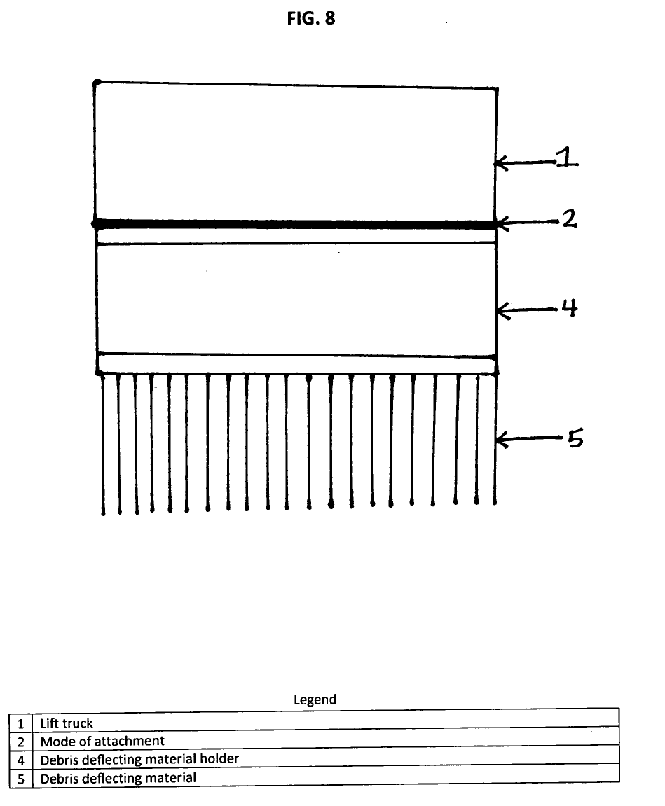

FIG. 9 depicts the side view of an adjustable embodiment of the debris deflecting lift truck wheel guard.

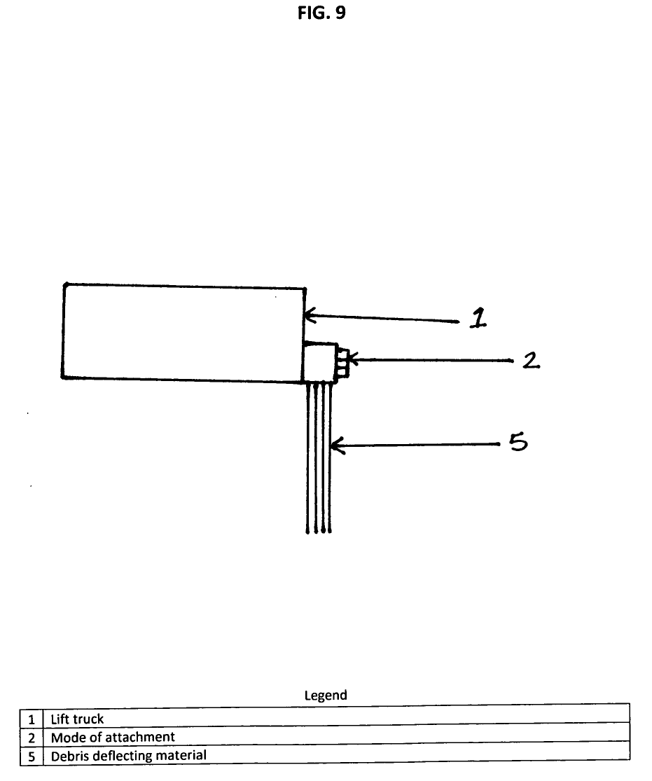

FIG. 10 depicts the front view of an adjustable embodiment of the debris deflecting lift truck wheel guard.

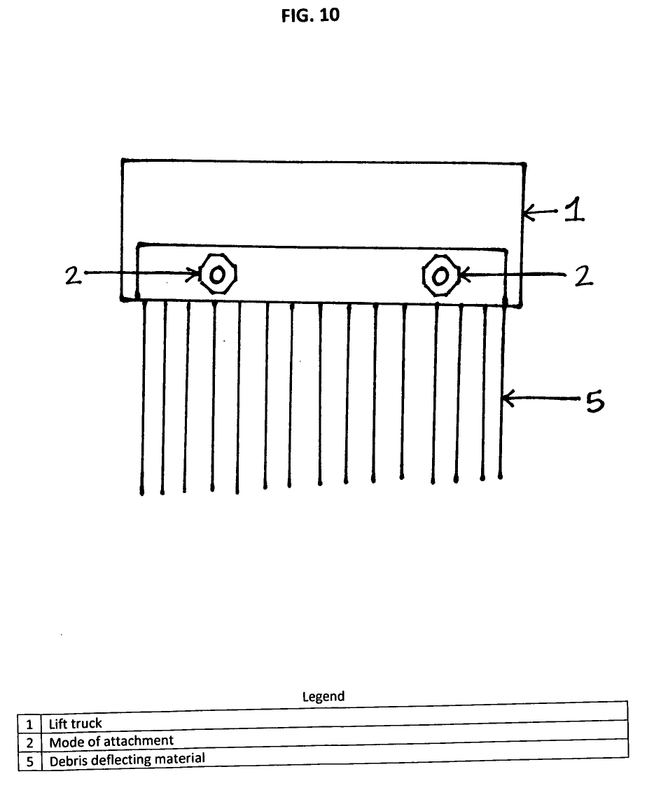

FIG. 11 depicts the side view of a non-adjustable embodiment of the debris deflecting lift truck wheel guard.

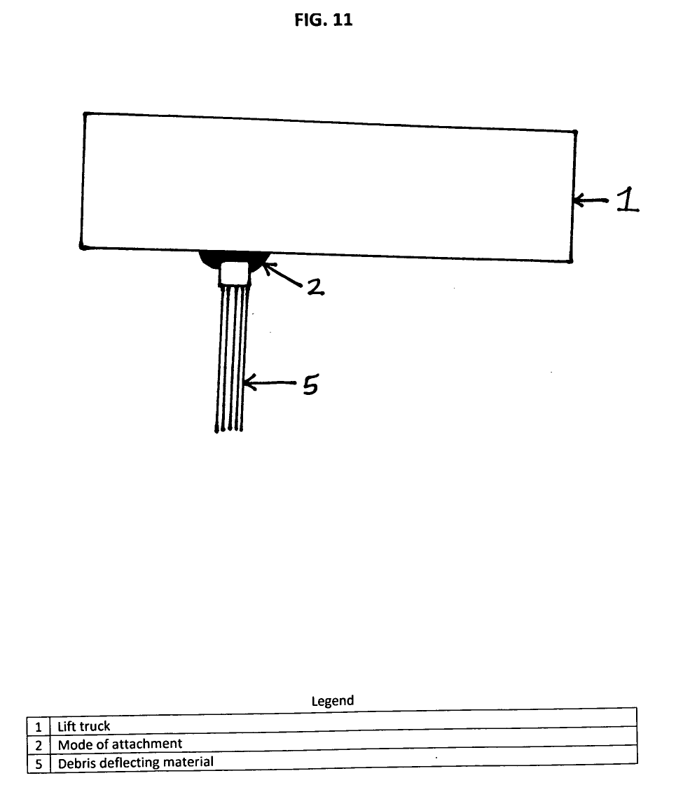

FIG. 12 depicts the front view of a non-adjustable embodiment of the debris deflecting lift truck wheel guard.

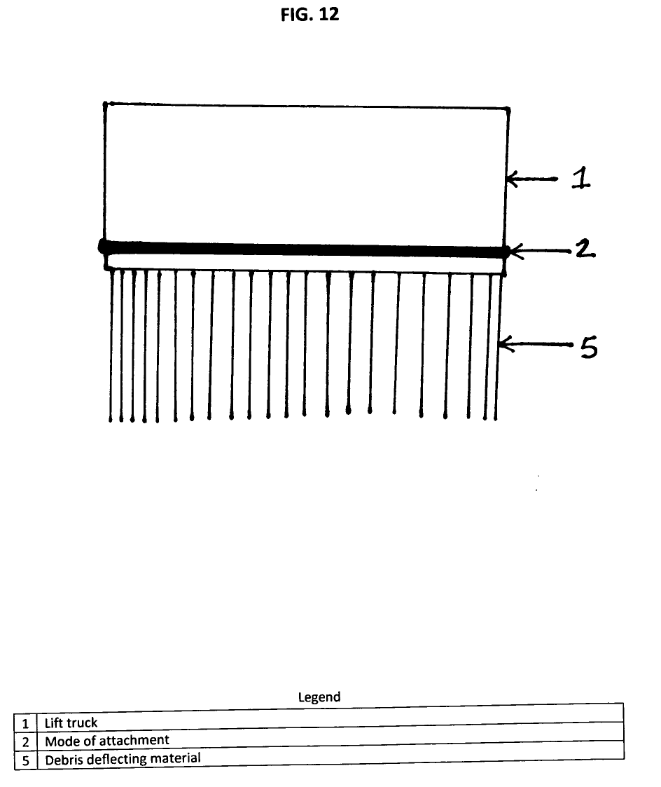

### DETAILED DESCRIPTION OF THE INVENTION

Three primary embodiments of this invention, which correlate to independent claims 1, 13, and 20, are described in the following description. The dependent claims describe the various secondary embodiments that are possible within each primary embodiment of the debris deflecting lift truck wheel guard.

First primary embodiment—claim 1: The first primary embodiment of the debris deflecting lift truck wheel guard is comprised of at least five main parts—the mounting plate, the deflecting-material holder, the deflecting material, and at least two modes of attachment.

The mounting plate is preferably a flat piece of metal or synthetic material that is made into the shape and size most appropriate for the particular model lift truck upon which it will be mounted. The shape and size needed is determined by the width of the wheel and the design of the lift truck. Depending on the embodiment made, the mounting plate's attachment points to the lift truck and to the deflecting-material holder can be adjustable or fixed. Also, depending on the embodiment made, the mounting plate can be attached to the lift truck in a fashion that requires that at least one opening be present in the mounting plate (i.e., when using a nut-and-bolt or other fastener type mode of attachment) or in a fashion that does not necessitate an opening (i.e., when using a weld or an adhesive as a mode of attachment). The location in which the mounting plate is attached is dependent upon the model of lift truck to which it is being attached since the location of the projected wheel path varies among different lift trucks.

The deflecting-material holder, which is preferably composed of metal or synthetic material, and the deflecting material, which is preferably composed of synthetic, natural, or metal materials, are both readily available on the market today. Both the deflecting-material holder and deflecting material are sold in various lengths and sizes and are easily cut to fit the mounting plate needed for a particular model lift truck. Depending on the embodiment made, the deflecting-material holder can be attached to the mounting plate using a mode of attachment method that requires that there be at least one opening in the deflecting-material holder, or it can be attached to the mounting plate using a mode of attachment method that does not necessitate that an opening be present. Further, depending on the embodiment made, the attachment point of the deflecting-material holder to the mounting plate can be adjustable or fixed (i.e., adjustability could be achieved via an opening and a nut-and-bolt or other fastener type mode of attachment, or a fixed attachment could be achieved via a weld or an adhesive type mode of attachment).

To assemble the first primary embodiment of the debris deflecting lift truck wheel guard, the mounting plate is attached to the lift truck via whichever mode of attachment is chosen to create the preferred embodiment. The proper location for attachment of the mounting plate to the lift truck is determined by assessing the projected wheel path. The deflecting material is attached to the deflecting-material holder. The deflecting-material holder, along with deflecting material, is attached to the mounting plate via the mode of attachment that yields the preferred embodiment. If creating a fixed embodiment, the deflecting-material holder should be attached to the mounting plate at a height that will allow the deflecting material to come into contact with the floor. If creating an adjustable embodiment, the deflecting material should be adjusted so that it makes contact with the floor.

Second primary embodiment—claim 13: The second primary embodiment of the debris deflecting lift truck wheel guard is comprised of at least three main parts—the deflecting-material holder, the deflecting material, and at least one mode of attachment. This embodiment is similar to the first except that here the deflecting-material holder is attached directly to the lift truck instead of to a mounting plate.

The deflecting-material holder, which is preferably composed of metal or synthetic material, and the deflecting material, which is preferably composed of synthetic, natural, or metal materials, are both readily available on the market today. Both the deflecting-material holder and deflecting material are sold in various lengths and sizes and are easily cut to fit the mounting plate needed for a particular model lift truck. Depending on the embodiment made, the deflecting-material holder can be attached to the lift truck using a mode of attachment method that requires that there be at least one opening in the deflecting-material holder, or it can be attached to the lift truck using a mode of attachment method that does not necessitate that an opening be present. Further, depending on the embodiment made, the attachment point of the deflecting-material holder to the lift truck can be adjustable or fixed (i.e., adjustability could be achieved via an opening and a nut-and-bolt or other fastener type mode of attachment, or a fixed attachment could be achieved via a weld or an adhesive type mode of attachment).

The deflecting material, which is preferably composed of synthetic, natural, or metal materials, is readily available on the market today. The deflecting material is sold in various lengths and sizes and is easily cut to fit the deflecting-material holder needed for a particular model lift truck.

To assemble the second primary embodiment of the debris deflecting lift truck wheel guard, the deflecting-material holder is attached to the lift truck via whichever mode of attachment is chosen to create the preferred embodiment. The proper location for attachment of the deflecting-material holder to the lift truck is determined by assessing the projected wheel path. The deflecting material is attached to the deflecting-material holder. If creating a fixed embodiment, the deflecting-material holder should be attached to the lift truck at a height that will allow the deflecting material to come into contact with the floor. If creating an adjustable embodiment, the deflecting material should be adjusted so that it makes contact with the floor.

Third primary embodiment—claim 20: The third primary embodiment of the debris deflecting lift truck wheel guard is comprised of at least two main parts—the deflecting material and at least one mode of attachment.

The deflecting material, which is preferably composed of synthetic, natural, or metal materials, is readily available on the market today. The deflecting material is sold in various lengths and sizes and is easily cut to the size needed for a particular model lift truck. The shape and size of deflecting material needed is determined by the width of the wheel and the design of the lift truck.

To assemble the third primary embodiment of the debris deflecting lift truck wheel guard, the deflecting material is attached to the proper location on the lift truck, which is determined by assessing the projected wheel path, by the mode of attachment that will create the preferred secondary embodiment—adjustable or fixed. Depending on the embodiment made and mode of attachment used, an opening may or may not be needed in the deflecting material. If creating a fixed embodiment, the deflecting material should be attached to the lift truck at a height that will allow it to come into contact with the floor. If creating an adjustable embodiment, the deflecting material should be adjusted so that it makes contact with the floor.

I claim:

1. A debris deflecting lift truck wheel guard, comprising:
A mounting plate secured to a lift truck by at least one mode of attachment;
A deflecting-material holder and deflecting material, said deflecting-material holder secured to said mounting plate by at least one mode of attachment.

2. The debris deflecting lift truck wheel guard of claim 1 wherein said mode(s) of attachment attaching said mounting plate to said lift truck is/are capable of adjusting the attachment point of said mounting plate to said lift truck.

3. The debris deflecting lift truck wheel guard of claim 1 wherein said mode(s) of attachment attaching said deflecting-material holder to said mounting plate is/are capable of adjusting the attachment point of said deflecting-material holder to said mounting plate.

4. The debris deflecting lift truck wheel guard of claim 1 wherein said mode(s) of attachment attaching said mounting plate to said lift truck is/are not capable of adjusting the attachment point of said mounting plate to said lift truck.

5. The debris deflecting lift truck wheel guard of claim 1 wherein said mode(s) of attachment attaching said deflecting-material holder to said mounting plate is/are not capable of adjusting the attachment point of said deflecting-material holder to said mounting plate.

6. The debris deflecting lift truck wheel guard of claim 1 wherein said mounting plate has at least one opening capable of receiving at least one mode of attachment to secure said mounting plate to said lift truck.

7. The debris deflecting lift truck wheel guard of claim 1 wherein said mounting plate has at least one opening capable of receiving at least one mode of attachment to secure said mounting plate to said deflecting-material holder.

8. The debris deflecting lift truck wheel guard of claim 1 wherein said deflecting-material holder has at least one opening capable of receiving at least one mode of attachment to secure said deflecting-material holder to said mounting plate.

9. The debris deflecting lift truck wheel guard of claim 1 wherein said mode(s) of attachment attaching said mounting plate to said lift truck does/do not necessitate any openings in said mounting plate.

10. The debris deflecting lift truck wheel guard of claim 1 wherein said mode(s) of attachment attaching said deflecting-material holder to said mounting plate does/do not necessitate any openings in said deflecting-material holder nor in said mounting plate.

11. The debris deflecting lift truck wheel guard of claim 1 wherein said deflecting material is further comprised of synthetic, natural, or metal materials.

12. The debris deflecting lift truck wheel guard of claim 1 wherein said mounting plate, deflecting-material holder, and modes of attachment are further comprised of metal or synthetic materials.

13. A debris deflecting lift truck wheel guard, comprising:
A deflecting-material holder with deflecting material secured to a lift truck by at least one mode of attachment.

14. The debris deflecting lift truck wheel guard of claim 13 wherein said mode(s) of attachment attaching said deflecting-material holder to said lift truck is/are capable of adjusting the attachment point of said deflecting-material holder to said lift truck.

15. The debris deflecting lift truck wheel guard of claim 13 wherein said mode(s) of attachment attaching said deflecting-material holder to said lift truck is/are not capable of adjusting the attachment point of said deflecting-material holder to said lift truck.

16. The debris deflecting lift truck wheel guard of claim 13 wherein said deflecting material holder has at least one opening capable of receiving at least one mode of attachment to secure said deflecting material to said lift truck.

17. The debris deflecting lift truck wheel guard of claim 13 wherein said mode(s) of attachment attaching said deflecting material holder to said lift truck does/do not necessitate any openings in said deflecting material holder.

18. The debris deflecting lift truck wheel guard of claim 13 wherein said deflecting material is further comprised of synthetic, natural, or metal materials.

19. The debris deflecting lift truck wheel guard of claim 13 wherein said deflecting-material holder and mode of attachment are further comprised of metal or synthetic materials.

20. A debris deflecting lift truck wheel guard, comprising:
Deflecting material secured to a lift truck by at least one mode of attachment.

21. The debris deflecting lift truck wheel guard of claim 20 wherein said mode(s) of attachment attaching said deflecting material to said lift truck is/are capable of adjusting the attachment point of said deflecting material to said lift truck.

22. The debris deflecting lift truck wheel guard of claim 20 wherein said mode(s) of attachment attaching said deflecting material to said lift truck is/are not capable of adjusting the attachment point of said deflecting material to said lift truck.

23. The debris deflecting lift truck wheel guard of claim 20 wherein said deflecting material has at least one opening capable of receiving at least one mode of attachment to secure said deflecting material to said lift truck.

24. The debris deflecting lift truck wheel guard of claim 20 wherein said mode(s) of attachment attaching said deflecting material to said lift truck does/do not necessitate any openings in said deflecting material.

25. The debris deflecting lift truck wheel guard of claim 20 wherein said deflecting material is further comprised of synthetic, natural, or metal materials.

26. The debris deflecting lift truck wheel guard of claim 20 wherein said mode of attachment is further comprised of metal or synthetic materials.
